(19) United States
(12) Patent Application Publication
(10) Pub. No.: US 2020/0137134 A1
(43) Pub. Date: Apr. 30, 2020

(54) MULTI-SESSION LOW LATENCY ENCODING

(71) Applicant: ATI TECHNOLOGIES ULC, Markham (CA)

(72) Inventors: Edward HAROLD, Markham (CA); Lei ZHANG, Markham (CA)

(21) Appl. No.: 16/176,489

(22) Filed: Oct. 31, 2018

(51) Int. Cl. H04L 29/06; H04N 19/176

(52) U.S. Cl. CPC H04L 65/607; H04L 65/1083; H04L 65/80; H04N 19/176

(57) ABSTRACT

An encoder of a multimedia system is configured to switch between encoding portions of frames at multiple encoding sessions based on configurable preemption requirements and stored context information. The encoder seamlessly encodes frames at multiple encoding sessions at low latency without introducing artifacts, such that the output bitstream is the same as if it were encoded at once as a single frame. Target bitrate and other encoder tunings also remain the same as if the entire frame were encoded at once.

### BACKGROUND

A multimedia application generates data representative of pictures in a multimedia stream, e.g., a multimedia stream that has been requested by a user. An encoder encodes the data for each picture and uses the encoded data to form a bitstream that is transmitted over a network to a decoder. The decoder decodes the bitstream and provides the decoded video information to a multimedia application or any other application for display to the user. In certain low latency multimedia encoding applications, multiple encoding sessions are active to encode data for different bitstreams at the same time. Encoded output from each session is required to be ready at a certain rate to meet latency requirements. For example, in some video applications, encoded output data is required to meet latency requirements to ensure a satisfactory user experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a multimedia system configured to switch from one encoding session to another encoding session in response to a preemption requirement being met in accordance with some embodiments.

FIG. 2 is a block diagram of an encoder configured to switch between encoding portions of frames from multiple encoding sessions in response to a preemption requirement being met in accordance with some embodiments.

FIG. 3 is a block diagram of an encoder configured to encode a predetermined portion of a frame of a first encoding session before switching to a second encoding session in accordance with some embodiments.

FIG. 4 is a block diagram of an encoder configured to encode a portion of a frame of a first encoding session until an encoded bitstream output size is met before switching to a second encoding session in accordance with some embodiments.

FIG. 5 is a block diagram of an encoder configured to encode a portion of a frame of a first encoding session until a time limit is met before switching to a second encoding session in accordance with some embodiments.

FIG. 6 is a flow diagram illustrating a method for switching between encoding portions of frames at multiple encoding sessions in response to a preemption requirement being met in accordance with some embodiments.

### DETAILED DESCRIPTION

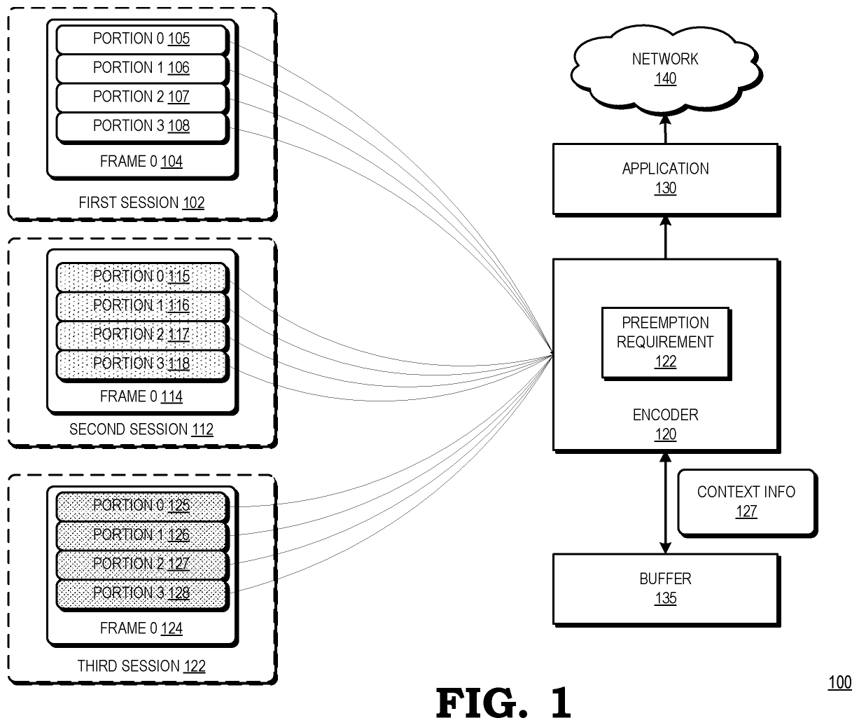

FIGS. 1-6 illustrate systems and techniques for switching between encoding portions of frames at multiple encoding sessions in response to a preemption requirement being met. To provide a satisfying user experience, many video processing applications, such as those used for cloud video gaming, require a single encoder to multiplex multiple encoding sessions and provide partial or full encoded output from each session at low latency. To save costs and because a single encoder can satisfy multiple sessions' aggregate throughput requirements, multiple sessions are time interleaved in a single encoder. For example, if two or more video applications are simultaneously active, an encoder must switch between encoding sessions to provide low latency output so that each video application can provide video content to one or more users in a timely fashion. However, conventional approaches to switching between encoding sessions at a frame boundary generally results in high latency, because the next encoding session must wait for the entire frame of the previous encoding session to be completed. Further, switching between encoding sessions at a slice boundary, as is done in some conventional systems, generally results in visual and objective quality loss, because blockiness and intra-prediction artifacts will be visible at slice boundaries due to spatial predictions not crossing slice boundaries for, e.g., the H.264 encoding standard. In addition, switching between encoding sessions at a slice boundary reduces compression efficiency due to the addition of a slice header at the beginning of each slice. Using the techniques described herein, an encoder switches between encoding sessions based on configurable preemption requirements and stored context information, thereby reducing the latency associated with the switching, enhancing the user experience.

To illustrate, the encoder of a multimedia system encodes a first portion of a frame at a first session until a preemption requirement is met. The preemption requirement is configurable to include any preemption condition suitable to application or system requirements, such as a predetermined portion size of a frame (e.g., number of coding blocks, such as macroblocks in the H.264 encoding standard), a predetermined encoded bitstream output size, or an encoding time limit for each encoding session. In response to the preemption requirement being met, the encoder outputs the encoded portion, stores session information and context for the encoded portion at a buffer, and sends feedback to the first session that the requested portion of the bitstream is ready so the multimedia application can start processing the bitstream with low latency. The encoder then switches to the next active session and encodes a first portion of a frame at the second session until a preemption requirement is met. In response to the preemption requirement, the encoder outputs the encoded portion of the frame of the second session, stores session information and context for the encoded portion at the buffer, and sends feedback to the second session that the requested portion of the bitstream is ready so the multimedia application can start processing the bitstream. Once all active encoding sessions are complete, the encoder returns to the first preempted session, loads the stored session information and context for the first session and encodes a second portion of the frame at the first session. By loading the stored session information and context, the encoder maintains continuity between encoding the first portion of the frame of the first session and encoding the second portion of the frame of the first session. By switching between active encoding sessions in response to a preemption requirement, and loading stored context information in response to returning to a previously preempted encoding session, the encoder seamlessly encodes frames at multiple encoding sessions at low latency without introducing artifacts, such that the output bitstream is the same as if it were encoded at once as a single frame. Target bitrate and other encoder tunings also remain the same as if the entire frame were encoded at once.

FIG. 1 illustrates a multimedia system 100 including an encoder 120 configured to switch between multiple encoding sessions 102, 112, 122 in response to a preemption requirement being met in accordance with some embodiments. The multimedia system 100 includes an encoder 120, a buffer 135, and an application 130. In some embodiments, the multimedia system 100 is distributed across a variety of electronic devices, such as a server, personal computer, tablet, set top box, gaming system, mobile phone, and the like. The encoder 120 is implemented as, for example, processors executing software, programmable logic, hard-coded logic, or a combination thereof. The encoder 120 is implemented with or otherwise associated with a source device (not shown) that communicates with a destination device (not shown) to provide images for display at a display device (not shown).

The encoder 120 is configured to receive digital information that represents a stream or sequence of image frames (e.g., frame 104) in a multimedia stream. The term “multimedia” refers to either video only or a combination of video and audio. The encoder 120 encodes the digital information for transmission over a network 140 such as a wide area network (WAN), an intranet, an Internet, a wireless network, and the like. For example, in some embodiments the encoder 120 is used to encode the digital information according to an encoding standard such as Moving Picture Expert Group (“MPEG”)-2, MPEG-4, Advanced Video Coding (“AVC”), and the like.

The encoder 120 is configured to switch between encoding portions of frames from multiple active sessions at low latency in response to a preemption requirement 122 being met. Thus, the encoder 120 temporarily suspends the encoding of a current frame of an active session and encodes a portion of a current frame of another active session. Each active session is associated with a client or an application. For example, in some embodiments, the encoder 120 switches between encoding bitstreams received from two or more clients, with each client bitstream representing an active session. In some embodiments, the encoder 120 switches between encoding bitstreams received from two or more applications, such as two or more video games being encoded by a single encoder, with each application representing an active session. In some embodiments, the encoder 120 switches between encoding bitstreams received from two or more virtual machines (VMs), which each VM representing an active session.

In the depicted example, the encoder 120 switches between encoding frames at three active encoding sessions: a first session 102, a second session 112, and a third session 122. The encoder 120 begins by encoding portion 0 105 of frame 104 at the first session 102. When the preemption requirement 122 is met, the encoder 120 outputs the encoded portion 0 105 to the application 130, stores session information and context 127 for the encoded portion 0 105 at the buffer 135, sends feedback to the first session 102 that requested portion of the bitstream is ready so the application 130 can start processing the bitstream, and preempts the first session 102. The session information and context 127 includes identification of the first session 102 and identification of information such as the frame, row, macroblocks, codec information, pixel values, configuration, and settings.

The encoder 120 then switches to the next active session to encode portion 0 115 of frame 0 114 at the second session 112 until the next preemption requirement 122 is met. In response to the preemption requirement 122 being met, the encoder 120 outputs the encoded portion 0 115 to the application 130, stores session information and context 127 for the encoded portion 0 115 at the buffer 135, sends feedback to the second session 112 that requested portion of the bitstream is ready so the application 130 can start processing the bitstream, and preempts the second session 112. The encoder 120 then switches to the next active session to encode portion 0 125 of frame 0 124 at the third session 122 until the next preemption requirement 122 is met. In response to the preemption requirement 122 being met, the encoder 120 outputs the encoded portion 0 125 to the application 130, stores session information and context 127 for the encoded portion 0 125 at the buffer 135, sends feedback to the third session 122 that requested portion of the bitstream is ready so the application 130 can start processing the bitstream, and preempts the third session 122. For ease of illustration, a single application 130 is illustrated as executing all three sessions 102, 112, 122, however, it is understood that in some embodiments different applications are executing at some or all of the sessions 102, 112, 122.

In response to determining that the encoder 120 has encoded a portion from each of the active sessions, the encoder 120 returns to the first session 102. The encoder loads the stored session information and context 127 for the previously encoded portion 0 105 from the buffer 135 and encodes the next portion 1 106 of frame 0 104 at the first session 102 based on the stored context 127. The encoder 120 continues switching between sessions in this fashion, such that, in the depicted example, the encoder encodes the portions of the frames of the first, second, and third sessions 102, 121, 122 in the following order: 1. Portion 0 105 (first session 102), 2. Portion 0 115 (second session 112), 3. Portion 0 125 (third session 122), 4. Portion 1 106 (first session 102), 5. Portion 1 116 (second session 112), 6. Portion 1 126 (third session 122), 7. Portion 2 107 (first session 102), 8. Portion 2 117 (second session 112), 9. Portion 2 127 (third portion 122), 10. Portion 3 108 (first session 102), 11. Portion 3 118 (second session 112), 12. Portion 3 128 (third session 122). After completing encoding all the portions of each of frame 0 104, 114, and 124, the encoder 120 proceeds to encode the first portion of the next frame of each session.

The preemption requirement 122 is configurable based on the latency and throughput requirements of the application 130 and the throughput rate of the encoder 120. For example, some applications have an end-to-end latency requirement from video capture to display of one to two frames. The preemption requirement 122 is programmably configured to meet the requirements of the application 130 and the capabilities of the encoder 120. In some embodiments, the preemption requirement 122 is based on a portion size of a frame. For example, in some embodiments, the preemption requirement 122 is met when a predetermined fraction (e.g., an eighth) of a frame has been encoded or when a predetermined number of macroblocks have been encoded. In some embodiments, the preemption requirement 122 is based on the encoded output of the encoder 122 reaching a predetermined size. For example, in some embodiments, the preemption requirement 122 is met when the size of the encoded portion output by the encoder 122 reaches the packet size for the network 140. Thus, once a predetermined number of bytes, based on the network packet size, is encoded, the preemption requirement 122 is met. In some embodiments, the preemption requirement 122 is based on a time limit, e.g., 1 ms, for each portion of a frame per encoding session.

By encoding a portion of each frame of each session at a time, the encoder 120 maintains a high throughput, resulting in low latency. Further, by storing and subsequently accessing session and context information 127 for each encoded portion, and basing the encoding of each successive portion of the frame for each session on the session and context information 127 of the previously encoded portion, the encoder 120 incrementally encodes all the portions of the frame such that, once the entire frame has been encoded, the encoded frame does not differ from a frame that was encoded in a single encoding session. Thus, by switching between sessions to encode portions of frames at each session in this manner, the encoder 120 reduces latency while retaining encoding quality.

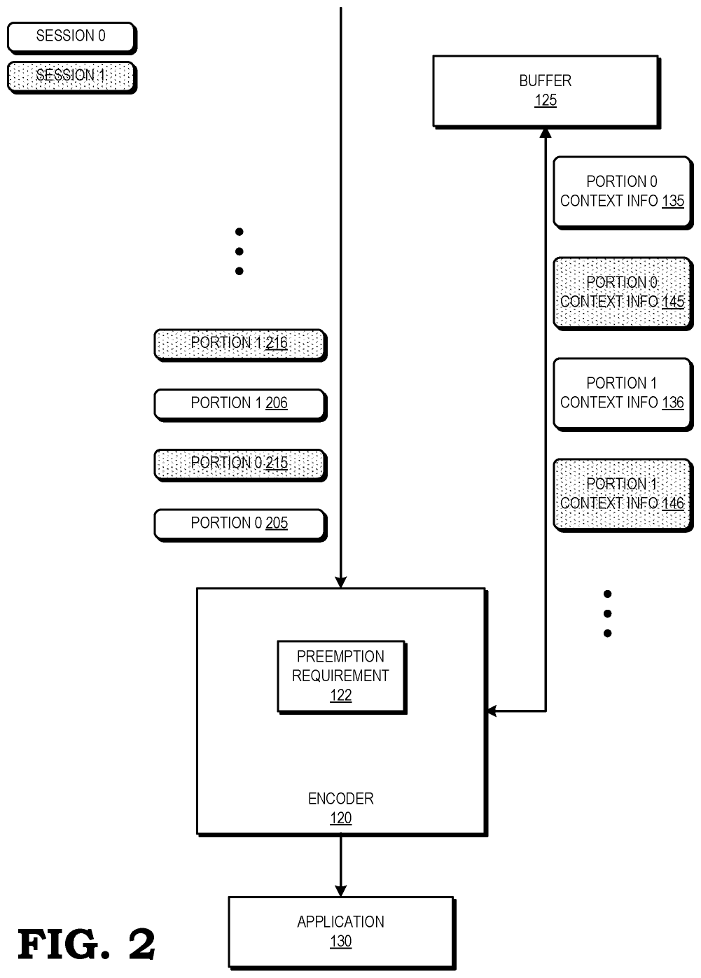

FIG. 2 is a block diagram of the encoder 120 of FIG. 1 encoding portions of frames from multiple encoding sessions in accordance with some embodiments. In the depicted example, the encoder 120 is encoding portions of frames at two encoding sessions (Session 0 and Session 1). The encoder 120 encodes portion 0 205 of a current frame at Session 0 until a preemption requirement 122 is met. When the preemption requirement 122 is met, the encoder 120 outputs the encoded portion to the application 130 and stores context information 135 for portion 0 of the current frame at session 0 at the buffer 125. The application 130 then begins processing portion 0 205. The encoder 120 then preempts the current session and moves to the next active session, Session 1. The encoder 120 encodes portion 0 215 of a current frame at Session 1 until the preemption requirement 122 is met. When the preemption requirement 122 is met, the encoder 120 outputs the encoded portion to the application 130 for immediate processing and stores context information 145 for portion 0 of the current frame at Session 1 at the buffer 125. The encoder 120 preempts the current session and, in response to detecting that there are no more active sessions, the encoder 120 returns to the first preempted session, Session 0.

The encoder 120 loads the context information 135 for portion 0 of the current frame at session 0 from the buffer 125. Based on the context information 135, the encoder 120 encodes the next portion (portion 1 206) of the current frame at Session 0 until the preemption requirement 122 is met. In response to the preemption requirement 122 being met, the encoder 120 outputs the encoded portion to the application 130 for processing and stores context information 136 for portion 1 of the current frame at Session 0 at the buffer 125. The encoder 120 preempts the current session and switches to the next active session, Session 1. The encoder loads the context information 145 for portion 0 of the current frame at Session 1 from the buffer 125. Based on the context information 145, the encoder 120 encodes the next portion (portion 1 216) of the current frame at Session 1 until the preemption requirement is met. In response to the preemption requirement 122 being met, the encoder 120 outputs the encoded portion to the application 130 for processing and stores context information 146 for portion 1 of the current frame at Session 1 at the buffer 125. The encoder 120 preempts the current session and, in response to detecting that there are no more active sessions, the encoder 120 returns to the first active session, Session 0 to repeat the process for the next portion.

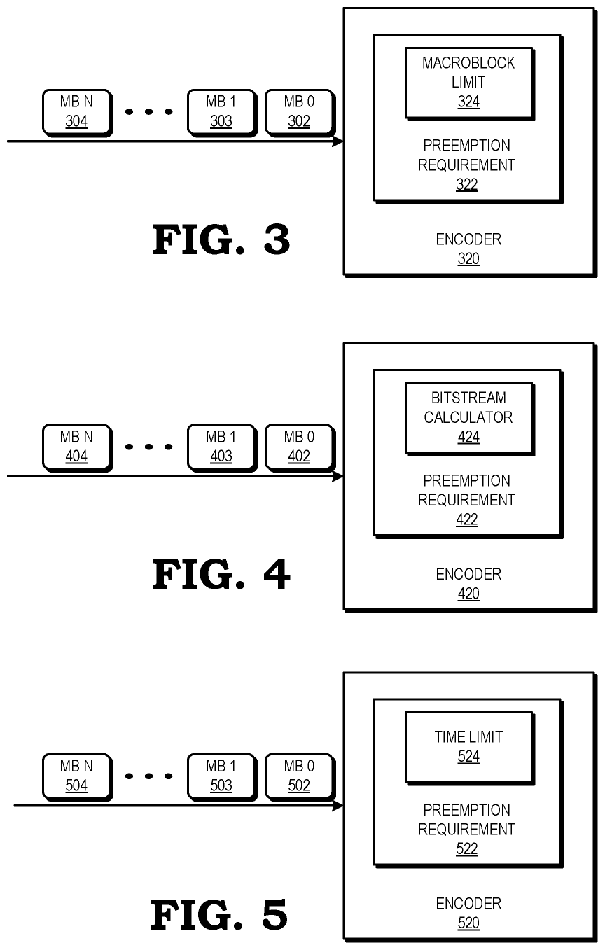

FIG. 3 is a block diagram of an encoder 320 configured to encode a portion of a frame of a first encoding session until a preemption requirement 322 of encoding a predetermined number of coding blocks (illustrated in FIG. 3 as macroblocks) is met before switching to a second encoding session in accordance with some embodiments. In the depicted example, the preemption requirement 322 is based on a number of macroblocks, macroblock limit 324, to be encoded for each session. In other embodiments, the preemption requirement 322 is based on a predetermined portion of a frame, e.g., an eighth of a frame, or a quarter of a frame.

In operation, the macroblock limit 324 is set to N macroblocks such that the preemption requirement 322 is met when the encoder 320 has completed encoding N macroblocks. The encoder 320 encodes macroblocks MB0 302, MB1 303, and so on until MBN 304, at which point the macroblock limit 324 has been reached and the preemption requirement 322 is met. The encoder 320 outputs the encoded macroblocks MB0 302, MB1 303, . . . , MBN 304 to an application (not shown) for processing, and stores session information and context (not shown) at a buffer (not shown). The encoder 320 preempts the current encoding session and switches to the next active session.

FIG. 4 is a block diagram of an encoder 420 configured to encode a portion of a frame of a first encoding session until a preemption requirement 422 based on an encoded bitstream output size is met before switching to a second encoding session in accordance with some embodiments. In the depicted example, the preemption requirement 422 is based on an encoded bitstream output limit, as calculated by bitstream calculator 424, for each encoding session. In some embodiments, the encoded bitstream output limit is based on a packet size for transmission across a network (not shown). For example, in some embodiments, the preemption requirement 422 is met when the bitstream calculator 424 determines that the encoder 420 has encoded a predetermined number of bytes of the current frame of the current active session.

In operation, the bitstream calculator 424 is set to a threshold size of M bytes before the preemption requirement 422 is met. The encoder 420 encodes macroblocks MB0 402, MB1 403, and so on until MBN 404, at which point the bitstream calculator 424 determines that the threshold of M bytes has been reached and the preemption requirement 422 is met. The encoder 420 outputs the encoded macroblocks MB0 402, MB1 403, . . . , MBN 404 to an application (not shown) for processing, and stores session information and context (not shown) at a buffer (not shown). The encoder 420 preempts the current encoding session and switches to the next active session.

FIG. 5 is a block diagram of an encoder 520 configured to encode a portion of a frame of a first encoding session until a preemption requirement 522 based on a time limit 524 is reached before switching to a second encoding session in accordance with some embodiments. In the depicted example, the preemption requirement 522 is based on a time limit 524 for each encoding session. In some embodiments, the time limit 524 is based on a latency requirement for transmitting portions of an encoded frame across a network (not shown).

In operation, the time limit 524 is set to a threshold time limit of X ms before the preemption requirement 522 is met. The encoder 520 encodes macroblocks MB0 502, MB1 503, and so on until MBN 504, until the time limit 524 of X ms has been reached and the preemption requirement 522 is met. The encoder 520 outputs the encoded macroblocks MB0 502, MB1 503, MBN 504 to an application (not shown) for processing, and stores session information and context (not shown) at a buffer (not shown). The encoder 520 preempts the current encoding session and switches to the next active session.

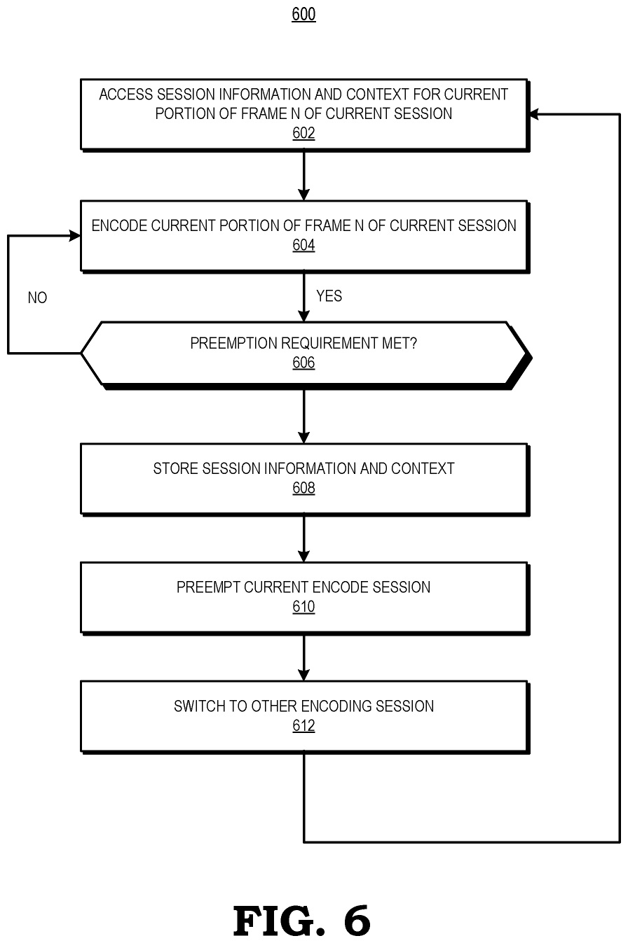

FIG. 6 is a flow diagram illustrating a method 600 for switching between encoding portions of frames at multiple encoding sessions in response to a preemption requirement being met implemented by the multimedia system 100 of FIG. 1 in accordance with some embodiments. At block 602, the encoder 120 accesses the buffer 125 to determine if the buffer 125 stores session information and context for a current portion of a current frame N of a current session. If the buffer 125 stores session information and context for the current portion of frame N of the current session, the encoder 120 loads the context information 127. At block 604, the encoder 120 encodes the current portion of frame N of the current session. At block 606, the encoder 120 determines whether a preemption requirement 122 has been met. If the preemption requirement 122 has not been met, the method flow continues back to block 604, and the encoder 120 continues encoding the current portion of frame N of the current session.

If, at block 606, the preemption requirement 122 has been met, the method flow continues to block 608. At block 608, the encoder 120 outputs the encoded portion of frame N at the current session to the application 130 for transmission across the network 140. At block 610, the encoder 120 stores session information and context 127 for the current portion of frame N of the current session at the buffer 125. At block 612, the encoder 120 preempts the current encoding session. At block 614, the encoder 120 switches to the next active encoding session, and the method flow continues back to block 602.

In some embodiments, the apparatus and techniques described above are implemented in a system having one or more integrated circuit (IC) devices (also referred to as integrated circuit packages or microchips), such as the multimedia system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium includes any non-transitory storage medium, or combination of non-transitory storage media, accessible by a computer system during use to provide instructions and/or data to the computer system. Such storage media includes, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software comprises one or more sets of executable instructions stored or otherwise tangibly embodied on a non-transitory computer readable storage medium. The software includes the instructions and certain data that, when executed by the one or more processors, manipulate the one or more processors to perform one or more aspects of the techniques described above. The non-transitory computer readable storage medium includes, for example, a magnetic or optical disk storage device, solid state storage devices such as Flash memory, a cache, random access memory (RAM) or other non-volatile memory device or devices, and the like. The executable instructions stored on the non-transitory computer readable storage medium is in source code, assembly language code, object code, or other instruction format that is interpreted or otherwise executable by one or more processors.

Note that not all of the activities or elements described above in the general description are required, that a portion of a specific activity or device is not necessarily required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
encoding a plurality of portions of a first frame and a second frame in multiple encoding sessions based on stored context information, the encoding comprising:
encoding a first portion of the first frame for a first session until a first configurable preemption requirement is met;
encoding a first portion of the second frame for a second session in response to the first preemption requirement being met until a second preemption requirement is met.

2. The method of claim 1, further comprising:
storing context information regarding the first portion of the first frame at a buffer in response to encoding the first portion of the first frame; and
accessing the stored context information regarding the first portion of the first frame in response to the second preemption requirement being met,
wherein encoding the second portion of the first frame for the first session is based on the stored context information regarding the first portion of the first frame.

3. The method of claim 2, wherein the context information comprises at least one of:
identification of a row of the first frame at which the first portion is located, identification of macroblocks comprising the first portion, pixel information associated with the first portion, and encoding settings used to encode the first portion.

4. The method of claim 1, wherein each portion of the plurality of portions comprises a predetermined number of macroblocks of the first frame and the second frame.

5. The method of claim 1, wherein the first preemption requirement comprises the encoded portion reaching a threshold size.

6. The method of claim 1, wherein the first preemption requirement comprises a threshold time limit being reached for encoding the first portion of the first frame.

7. The method of claim 1, further comprising:
encoding a second portion of the first frame for the first session in response to the second preemption requirement being met until a third preemption requirement is met; and
encoding a second portion of the second frame for the second session in response to the third preemption requirement being met.

8. A method, comprising:
switching, at an encoder, between encoding portions of first frame of a first session and encoding portions of a second frame of a second session based on stored context information in response to at least one preemption requirement being met; and
transmitting each encoded portion of the first frame and the second frame across a network in response to the encoder encoding each portion.

9. The method of claim 8, wherein switching comprises:
encoding a first portion of the first frame until a first preemption requirement is met;
encoding a first portion of the second frame in response to the first preemption requirement being met until a second preemption requirement is met;
encoding a second portion of the first frame in response to the second preemption requirement being met until a third preemption requirement is met; and
encoding a second portion of the second frame in response to the third preemption requirement being met.

10. The method of claim 9, further comprising:
storing context information regarding the first portion of the first frame at a buffer in response to encoding the first portion of the first frame; and
accessing the stored context information regarding the first portion of the first frame in response to the second preemption requirement being met,
wherein encoding the second portion of the first frame for the first session is based on the stored context information regarding the first portion of the first frame.

11. The method of claim 10, wherein the context information comprises at least one of:
identification of a row of the first frame at which the first portion is located, identification of macroblocks comprising the first portion, pixel information associated with the first portion, and encoding settings used to encode the first portion.

12. The method of claim 8, wherein each portion of the first frame comprises a predetermined number of macroblocks of the first frame and each portion of the second frame comprises a predetermined number of macroblocks of the second frame.

13. The method of claim 8, wherein at least one preemption requirement comprises the encoded portion reaching a threshold size.

14. The method of claim 8, wherein at least one preemption requirement comprises a threshold time limit being reached for encoding a portion of the first frame.

15. A device, comprising:
an encoder configured to switch between encoding portions of first frame of a first session for transmission across a network and encoding portions of a second frame of a second session based on stored context information for transmission across the network in response to at least one preemption requirement being met.

16. The device of claim 15, wherein the encoder is further configured to:
encode a first portion of the first frame until a first preemption requirement is met;
encode a first portion of the second frame in response to the first preemption requirement being met until a second preemption requirement is met;
encode a second portion of the first frame in response to the second preemption requirement being met until a third preemption requirement is met; and
encode a second portion of the second frame in response to the third preemption requirement being met.

17. The device of claim 16, further comprising:
a buffer,
wherein the encoder is further configured to:
store context information regarding the first portion of the first frame at the buffer in response to encoding the first portion of the first frame; and
access the stored context information regarding the first portion of the first frame in response to the second preemption requirement being met,
and wherein the encoder is configured to encode the second portion of the first frame for the first session based on the stored context information regarding the first portion of the first frame.

18. The device of claim 15, wherein each portion of the first frame comprises a predetermined number of macroblocks of the first frame and each portion of the second frame comprises a predetermined number of macroblocks of the second frame.

19. The device of claim 15, wherein at least one preemption requirement comprises the encoded portion reaching a threshold size.

20. The device of claim 15, wherein at least one preemption requirement comprises a threshold time limit being reached for encoding a portion of the first frame.
